(19) United States
(12) Patent Application Publication
(10) Pub. No.: US 2014/0089168 A1
(43) Pub. Date: Mar. 27, 2014

(54) COMPLIANCE REVIEW

(71) Applicant: Treliant Risk Advisors, LLC, Washington, DC (US)

(72) Inventors: Shelley Metz-Galloway, North Bethesda, MD (US); Kristine Curl, Commerce City, CO (US); Sydney Fetter, Placitas, NM (US); Doug Disesa, Wynnewood, PA (US)

(73) Assignee: Treliant Risk Advisors, LLC, Washington, DC (US)

(21) Appl. No.: 14/027,888

(22) Filed: Sep. 16, 2013

Related U.S. Application Data
(60) Provisional application No. 61/701,481, filed on Sep. 14, 2012.

(51) Int. Cl. G06Q 30/00; G06Q 50/16

(52) U.S. Cl. CPC G06Q 30/018; G06Q 40/025; G06Q 50/16
USPC 705/38

(57) ABSTRACT

One or more devices in a mortgage loan compliance review system may be configured to receive and analyze mortgage loan data, and to perform various mortgage loan compliance determinations and actions based on the mortgage loan data. One or more compliance review computing devices may receive and store multiple sets of mortgage loan data, such as initial sets of customer fee data from one or more Good Faith Estimates (GFEs), and final set of customer fee data from a HUD-1 document, along with along with Change of Circumstance forms and other loan documents. The compliance review system may identify fee differences across different sets of mortgage loan data, compare fee differences to predefined fee tolerances, determine validity of certain customer fees, and calculate customer remediation amounts for mortgage loans.

### CROSS REFERENCE TO RELATED APPLICATIONS

The present application is a non-provisional of U.S. Provisional Application No. 61/701,481, entitled “Compliance Review System,” filed Sep. 14, 2012, the contents of which are hereby incorporated by reference in their entirety for all purposes.

### BACKGROUND

Mortgage lending is a highly regulated industry including many rules and regulations, among them the Real Estate Settlement Procedures Act (RESPA). One of the regulations under RESPA, Regulation X, includes precise guidelines relating to the disclosure and final settlement of fees charged as part of the consumer home mortgage loan closing process. Compliance with Regulation X and other rules governing mortgage loans is a priority for banks and other mortgage lenders, both to assure compliance with the applicable rules and regulations for current mortgage loans, and to confirm compliance for past mortgage loans and make any customer remediation necessitated by non-compliance.

Mortgage loan files typically range from one-hundred to five-hundred (100-500) pages in length, and may or may not be digitized. Loan file reviews are often conducted manually. Physical mortgage loan documents may be collected and put into a single loan file, which may be stored in a secure archive facility. Security of loan files is of high importance, as such files contain confidential mortgage loan data and customer financial data. When performing a review on a loan file, the review may be conducted on the physical file, or by scanning the physical file into an electronic format (e.g., Adobe Portable Document Format (PDF)). For mortgage loan reviews associated with RESPA and Regulation X, the review often focuses on particular loan documents that include itemized fees that will be charged to consumers, for example, a final HUD-1 document, one or more Good Faith Estimates (GFEs), a Settlement Servicers Provider List (SSPL), a Loan Pricing Agreement (LPA), and one or more the Change of Circumstance forms. These documents, among others, may contain dozens or even hundreds of fees that need to be analyzed during loan file reviews.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to apparatuses, computer-implemented methods, and computer-readable media for receiving and analyzing mortgage loan data, and performing various mortgage loan compliance determinations and actions based on the mortgage loan data. A compliance review computing device or system, for example, compliance review server, mortgage lender computing device, and/or customer terminal, may receive and store multiple sets of mortgage loan data. Mortgage loan data may include one or more initial sets of customer fee data from Good Faith Estimates (GFEs), a final set of customer fee data from a HUD-1 document, along with Change of Circumstance forms and various other loan documents. Fee differences may be identified across different sets of mortgage loan data, and predefined fee tolerances for individual customer fees may be compared to the fee differences to determine the validity status (e.g., valid or invalid) for certain customer fees and/or tag certain customer fees for further analysis via a specialized user interface. Customer remediation amounts may be calculated in some embodiments, based on the identification of invalid or potentially invalid customer fees. Additionally, in some embodiments, one or more user interfaces may be provided to support fee tagging and multi-level compliance reviews of mortgage loans.

Other features and advantages of the disclosure will be apparent from the additional description provided herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network environment and computer systems that may be used to implement aspects of the disclosure.

FIG. 2 is a diagram illustrating various components of a compliance review system, according to one or more aspects of the disclosure.

FIG. 3 is a flow diagram illustrating an example of receiving and analyzing mortgage loan data to determine fee validity and calculate a customer remediation amount, according to one or more aspects of the disclosure.

FIGS. 4 and 5 are example user interface screens provided in a compliance review system to receive mortgage loan data, according to one or more aspects of the disclosure.

FIG. 6 is an example remediation summary user interface screen provided in a compliance review system, according to one or more aspects of the disclosure.

FIG. 7 is an example dynamic fee comparison user interface screen provided in a compliance review system, according to one or more aspects of the disclosure.

FIGS. 8-11 are example mortgage loan review user interface screens provided in a compliance review system, according to one or more aspects of the disclosure.

FIG. 12 is a flow diagram illustrating an example of calculating an updated remediation amount based on updated fee validity data in a multi-level compliance review, according to one or more aspects of the disclosure.

FIG. 13 is an example mortgage loan review user interface provided in a compliance review system, according to one or more aspects of the disclosure.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

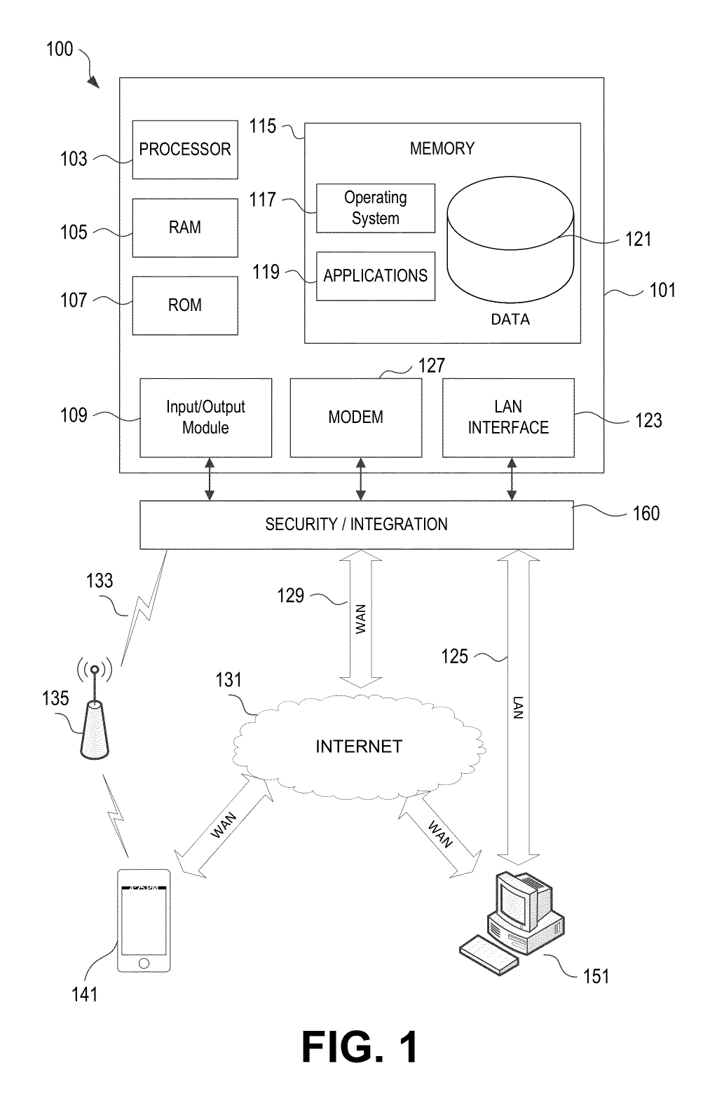

FIG. 1 illustrates a block diagram of a computing device (or system) 101 in a computer system 100 that may be used according to one or more illustrative embodiments of the disclosure. The device 101 may have a processor 103 for controlling overall operation of the device 101 and its associated components, including RAM 105, ROM 107, input/output module 109, and memory 115. The computing device 101, along with one or more additional devices (e.g., terminals 141 and 151, security and integration hardware 160) may correspond to any of multiple systems or devices, such as a mortgage loan compliance review computing device or system, a mortgage lender device or system, or a customer device or system, configured as described herein for receiving and analyzing mortgage loan data, and performing various mortgage loan compliance determinations and actions based on the mortgage loan data.

Input/Output (I/O) 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to processor 103 for enabling device 101 to perform various actions. For example, memory 115 may store software used by the device 101, such as an operating system 117, application programs 119, and an associated internal database 121. The various hardware memory units in memory 115 may include volatile and nonvolatile, removable and non-removable media implemented in any method or technology for storage of information such as computer readable instructions, data structures, program modules or other data. In some examples, one or more nonvolatile hardware memory units having at least 5 gigabytes (GB) of memory may be used in device 101, in order to support sufficient mortgage loan data and multiple levels of compliance reviews, in certain embodiments of compliance review systems. Memory 115 also may include one or more physical persistent memory devices and/or one or more non-persistent memory devices. Memory 115 may include, but is not limited to, random access memory (RAM) 105, read only memory (ROM) 107, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Processor 103 may include a single central processing unit (CPU), which may be a single-core or multi-core processor (e.g., dual-core, quad-core, etc.), or may include multiple CPUs. Processor(s) 103 may have various bit sizes (e.g., 16-bit, 32-bit, 64-bit, 96-bit, 128-bit, etc.) and various processor speeds (ranging from 100 MHz to 5 Ghz or faster). Processor(s) 103 and its associated components may allow the system 101 to execute a series of computer-readable instructions, for example, to receive and store mortgage loan data, to provide multiple levels of compliance review for the mortgage loan, and to calculate customer remediation amounts.

The computing device 101 (e.g., a customer terminal, a mortgage lender computing device, a compliance review computer hardware memory and processor system, etc.) may operate in a networked environment 100 supporting connections to one or more remote computers, such as terminals 141 and 151. The terminals 141 and 151 may be personal computers, servers (e.g., web servers, database servers), or mobile communication devices (e.g., mobile phones, portable computing devices, and the like), and may include some or all of the elements described above with respect to the computing device 101. The network connections depicted in FIG. 1 include a local area network (LAN) 125 and a wide area network (WAN) 129, and a wireless telecommunications network 133, but may also include other networks. When used in a LAN networking environment, the computing device 101 may be connected to the LAN 125 through a network interface or adapter 123. When used in a WAN networking environment, the device 101 may include a modem 127 or other means for establishing communications over the WAN 129, such as network 131 (e.g., the Internet). When used in a wireless telecommunications network 133, the device 101 may include one or more transceivers, digital signal processors, and additional circuitry and software for communicating with wireless computing devices 141 (e.g., mobile phones, portable customer computing devices) via one or more network devices 135 (e.g., base transceiver stations) in the wireless network 133.

Also illustrated in FIG. 1 is a security and integration layer 160, through which communications are sent and managed between the device 101 (e.g., a compliance review computing device or system) and the remote devices 141 and 151 (e.g., customer terminals, mortgage lender computing devices, governmental data sources, etc.) and remote networks (125, 129, and 133). The security and integration layer 160 may comprise one or more computing devices, such as web servers, authentication servers, and various networking components (e.g., firewalls, routers, gateways, load balancers, etc.), having some or all of the elements described above with respect to the computing device 101. As an example, security and integration layer 160 may comprise a set of web application servers configured to use secure protocols and to insulate the compliance review computing device or system 101 from external devices 141 and 151. In some cases, the security and integration layer 160 may correspond to a set of dedicated hardware and/or software operating at the same physical location and under the control of same entities as the compliance review computing device or system servers and devices 101. For example, layer 160 may correspond to one or more dedicated web servers and network hardware in a compliance review datacenter or in a cloud infrastructure supporting a cloud-based compliance review system. In other examples, the security and integration layer 160 may correspond to separate hardware and software components which may be operated at a separate physical location and/or by a separate entity.

As discussed below, the data transferred to and from a computing device 101 in a compliance review computing device or system may include secure and sensitive data, such as mortgage loan files containing personal and financial information of mortgage customers. Therefore, it may be desirable to protect the data transmission by using secure network protocols and encryption, and also to protect the integrity of the data stored when on the compliance review computing devices or system server(s) 101 using the security and integration layer 160 to authenticate users and restrict access to unknown or unauthorized users. In various implementations, security and integration layer 160 may provide, for example, a file-based integration scheme or a service-based integration scheme. In filed-based integration, data files may be transmitted to and from the compliance review computing device or system server(s) 101 through the security and integration layer 160, using various network communication protocols. Secure data transmission protocols and/or encryption may be used in file transfers to protect to integrity of the mortgage loan data, for example, File Transfer Protocol (FTP), Secure File Transfer Protocol (SFTP), and/or Pretty Good Privacy (PGP) encryption.

In service-based integration, one or more web services may be implemented within the compliance review computing device or system 101 and/or security and integration layer 160. The web services may be accessed by authorized external devices and users to support input, extraction, and manipulation of the data in the compliance review computing system server(s) 101. Web services built to support to the compliance review system may be cross-domain and/or cross-platform, and may be built for enterprise use. Such web services may be developed in accordance with various web service standards, such as the Web Service Interoperability (WS-I) guidelines. In some examples, a compliance review system web service may be implemented in the security and integration layer 160 using the Secure Sockets Layer (SSL) or Transport Layer Security (TLS) protocol to provide secure connections between compliance review system devices and servers 101 and various clients 141 and 151 (e.g., mortgage lenders, mortgage customers) attempting to insert or manipulate data within the database. SSL or TLS may use HTTP or HTTPS to provide authentication and confidentiality. In other examples, a compliance review system web service may be implemented using the WS-Security standard, which provides for secure SOAP messages using XML encryption. In still other examples, the security and integration layer 160 may include specialized hardware for providing secure web services. For example, secure network appliances in the security and integration layer 160 may include built-in features such as hardware-accelerated SSL and HTTPS, WS-Security, and firewalls. Such specialized hardware may be installed and configured in the security and integration layer 160 in front of the web servers, so that any external devices may communicate directly with the specialized hardware.

Although not shown in FIG. 1, various elements within memory 115 or other components in system 100, may include one or more caches, for example, CPU caches used by the processing unit 103, page caches used by the operating system 117, disk caches of a hard drive, and/or database caches used to cache content from database 121. For embodiments including a CPU cache, the CPU cache may be used by one or more processors in the processing unit 103 to reduce memory latency and access time. In such examples, a processor 103 may retrieve data from or write data to the CPU cache rather than reading/writing to memory 115, which may improve the speed of these operations. In some examples, a database cache may be created in which certain data from a database 121 (e.g., a mortgage loan database) is cached in a separate smaller database on an application server separate from the database server. For instance, in a multi-tiered application, a database cache on an application server can reduce data retrieval and data manipulation time by not needing to communicate over a network with a back-end database server. These types of caches and others may be included in various embodiments, and may provide potential advantages in certain implementations of compliance review systems, such as faster response times and less dependence on network conditions when accessing the compliance review devices or systems 101 to update or retrieve mortgage loan data, calculate customer remediation amounts, and provide multi-level compliance reviews.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computer devices and compliance review computing system components described herein may be configured to communicate using any of these network protocols or technologies.

Additionally, one or more application programs 119 may be used by the computing device 101 within a compliance review system, including computer executable instructions for receiving and analyzing mortgage loan data, calculating customer remediation amounts, providing multi-level compliance review and tagging for mortgage fees, and performing other related functions as described herein.

In the following description of the various embodiments, reference is made to the accompanying drawings, which form a part hereof, and in which is shown by way of illustration, various embodiments of the disclosure that may be practiced. It is to be understood that other embodiments may be utilized.

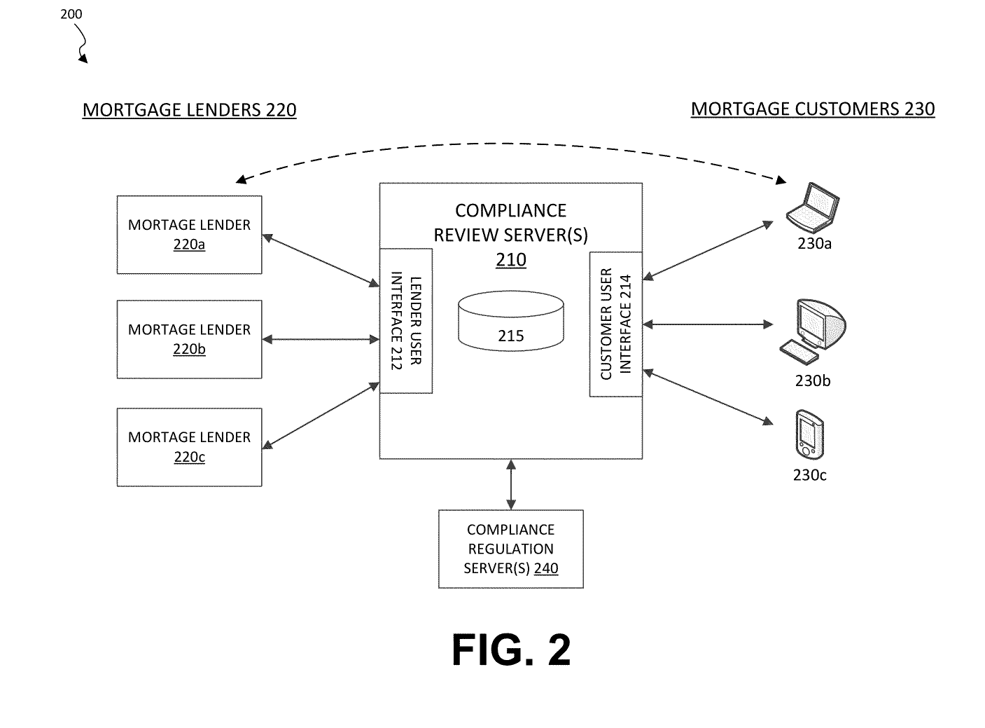

FIG. 2 is a diagram of a compliance review system 200. In the example compliance review system 200, a compliance review server 210 may communicate with a plurality of different mortgage lenders 220, mortgage customers 230, and/or compliance regulation servers 240. Each component shown in FIG. 2 may be implemented in hardware, software, or a combination of the two. Additionally, each component of the compliance review system 200 may include one or more computing devices (or systems) having some or all of the structural components described above for computing device 101.

Customer terminals 230a-230c may include any computing systems and devices, such as personal computers, mobile devices (e.g., smartphones, personal digital assistants, etc.) laptop computers, tablets, or computer servers, that may be used by a mortgage customer (or potential mortgage customer) to communicate with a mortgage lender 220 and/or with a mortgage loan compliance review server 210. Client software applications (e.g., a web browser or stand-alone client application) executing on customer terminals 230 may provide the functionality for users/customers to establish connections with mortgage lender servers 220 or compliance review servers 210, submit mortgage loan data, and receive customer remediation information and/or payment from a mortgage lender servers 220 or compliance review servers 210. In order to facilitate communication with compliance review servers 210, mortgage lenders 220, and other related mortgage loan devices, customer terminals 230 may include one or more client software applications configured to allow users to perform various mortgage loan compliance analysis-related actions, for example, a web browser (e.g., for web-browser based communication with compliance review servers 210, mortgage lenders 220, and other entities), a web-based mobile application (e.g., a mobile platform-based software application developed and published by a mortgage lender financial institution, a third-party compliance review system, or other entity), or a standalone application (e.g., a non-web-based software application executable on a customer terminal 230).

The compliance review system 200 shown in FIG. 2 also includes a plurality of mortgage lenders 220a-220c. Mortgage lenders 220 may correspond to devices or systems operated by banks or other financial institutions. Each mortgage lender 220 may be implemented using one or more individual computer servers (e.g., web servers, application servers, authentication servers, database servers, etc.), or combinations of servers and/or other computing devices. Such mortgage lender servers 220 may include various software and hardware components configured to communicate with customer terminals 230, as well as with one or more compliance review systems 210. For example, mortgage lender servers 220 may include software applications and modules to provide server-side functionality (e.g., web server or application server) to support mortgage customers and provide mortgage loan compliance review functionality to customers at terminals 230. For instance, mortgage lender servers 220 may include software for establishing connections with customer terminals 230, receiving identification data and mortgage loan data from customers (or potential customers), identifying and authenticating customers, providing compliance review applications and forms (e.g., web-based applications, mortgage data entry forms, questionnaires, etc.), processing the compliance review data, determining mortgage loan compliance with various regulations, calculating remediation amounts for which customers may be eligible, and communicating the compliance review analysis data and remediation amounts with customers via terminals 230. Additionally, as discussed below, mortgage lender servers 220 may be configured to receive mortgage loan data based on various interactions with customers, and then provide the mortgage loan data to one or more compliance review servers 210. Mortgage lender servers 220 also may include software applications or modules to retrieve results of mortgage loan compliance reviews compliance review servers 210, analyze the results, and perform various determinations and actions (e.g., notifying customers of remediation amounts, making remediation payments, and generating mortgage loan compliance reports associated with various mortgage lender personnel such as loan officers, loan processors, and underwriters) based on the analysis performed by the compliance review servers 210.

The compliance review system 200 shown in FIG. 2 also includes one or more compliance review servers 210. In this example, the compliance review servers 210 may be a single central computer system comprising one or more computing devices (e.g., application servers, database servers) configured to store and analyze mortgage loan data associated with a plurality of mortgage lenders 220a-220c and/or customers 230a-230c. As shown in FIG. 2, the compliance review servers 210 may include one or more databases 215 configured to store mortgage loan data received from various mortgage lenders 220 (e.g., via one or more lender user interfaces 212) and/or customers 230 (e.g., via one or more customer user interfaces 214). Such databases 215 may be implemented using specialized database servers and database software, or may be implemented using other computerized storage techniques (e.g., spreadsheets, text-based storage, etc.). As discussed above, the compliance review server 210 (or multiple compliance review servers 210) each may include a security and integration layer 160 to assure data security and integrity by controlling access to and transmission of mortgage loan data to or from the compliance review servers 210. Compliance review systems and/or security and integration layers 160 may implement file-based or service-based integration schemes.

As shown in FIG. 2, compliance review servers 210 may include one or more lender user interfaces 212 and customer user interfaces 214 for receiving mortgage loan data and providing compliance review results to mortgage lenders 220 and/or customers 230. For example, in some embodiments, mortgage loan customers 230 (e.g., current and/or potential customers) may directly input their mortgage loan data via user interface 214 to receive the results of a mortgage compliance review analysis performed by a compliance review server 210. In such examples, the customer user interface 214 may be a web-based user interface (e.g., provided by a web server 210) or a standalone client application interface (e.g., provided by an application server 210) supporting a client-server application architecture with customer terminals 230, configured to establish communication with a customer terminal 230, receive secure mortgage data from the customer terminal 230, and provide the compliance review output to the customer terminal 230. In other examples, the compliance review system 210 may provide an application programming interface (API) 214 for customers and third-party application developers to develop mortgage loan compliance review applications for customers.

In other examples, mortgage lenders 220 may provide mortgage loan data to compliance review servers 210 via lender user interfaces 212. In some cases, a mortgage lender user interface 212 may be configured to accept user input corresponding to individual mortgage loan data, and thus may include user input components (e.g., web-browser forms, etc.) similar to those provided by a customer interface 214. Such components may allow mortgage lender personnel (e.g., loan officers, processors, and underwriters) to input mortgage data and perform a compliance review for an individual loan. In additional examples, lender user interfaces 212 may allow mortgage lenders 220 to upload batches of mortgage loan data to a compliance review server 210 to perform compliance reviews (individually or together) for the batch of mortgage loans. For instance, mortgage lender personnel may upload a batch of mortgage loan data via secure file transfer (e.g., FTP or SFTP) or via a web service to the compliance review server 210, which may perform a batch analysis of several different mortgage loans associated with the same mortgage lender. In some cases, batches of mortgage loans having one or more common characteristics (e.g., the same loan types, similar loan amounts, the same loan officer or other associated personnel, etc.) may be analyzed together by a compliance review server 210 in order to generate a compliance report for a mortgage lender based on the common characteristics (e.g., an overall compliance review for various loan types and/or loan value ranges, a compliance report card for various mortgage lender offices or personnel, etc.).

As discussed below in more detail, after receiving mortgage loan data from various sources (e.g., mortgage lenders 220 and/or customers 230), the compliance review servers 210 may be configured to perform compliance review analyses of the mortgage loan data and/or to provide various user functionality related to the compliance review analyses (e.g., providing multi-level reviewer support for tagging customer fees and calculating remediation amounts, providing access to source document, etc.). As part of a compliance review analysis, a compliance review server 210 also may communicate with one or more compliance regulation servers 240 (e.g., governmental data sources). As discussed below, various regulatory requirements may be associated with specific mortgage loan customer fees (e.g., maximum fee amounts, etc.) and/or changes to specific mortgage loan customer fees (e.g., tolerances of fee change amounts, limits of dates of fee changes, etc.).

In some examples, the compliance review servers 210 may store data associated with different mortgage lenders 220 in different logical or physical storage locations. For instance, mortgage data received from a first mortgage lender server 220a may be stored in a different table, file, or on a different database server 215 than mortgage data received from a second mortgage lender server 220b. Such examples may be implemented in order to preserve data integrity and maintain security and privacy for the mortgage lenders 220 and customers. In other examples, data from different mortgage lenders 220 may be stored in a database 215 within the compliance review servers 210 in a uniform manner and within the same logical and/or physical storage locations. In some cases, the mortgage loan data from different mortgage lender servers 220 may be received in different data formats and/or data types, and the compliance review servers 210 may first convert the data into a uniform type and format before storing the data within its databases 215.

Although the compliance review servers 210 are shown in FIG. 2 as a separate component from the mortgage lenders 220 and customers 230, in certain embodiments some or all of the structure hardware components and/or logical software components of the compliance review servers 210 may be implemented within mortgage lender computing devices 220 or customer devices 230. For example, a mortgage lender 220 may implement a compliance review server 210, on new or existing hardware within its computing infrastructure 220, to allow internal personnel and/or customers 230 to perform compliance reviews for mortgage loans. In other examples, a compliance review system may be implemented in software that may be downloaded and executed on a customer terminal 230, to allow customers to perform compliance reviews of their mortgage loans.

In certain embodiments, the compliance review servers 210 may operate in a datacenter maintained by one or more mortgage lenders 220. In other embodiments, the compliance review servers 210 may be maintained by a third-party datacenter, or by a cloud provider using cloud-based technologies. For instance, a cloud provider may store and provide access to a mortgage loan database 215 for a plurality of mortgage lenders 220a-220c, such that the mortgage loan database 215 is stored at a remote off-site location, and is made accessible to the mortgage lenders 220 via virtual machines. In such implementations, the cloud provider may provide the data storage for the compliance review system 200 in a secure and scalable remote system. The cloud provider may be a separate entity from any of the mortgage lenders 220, so that each mortgage lender may send its secure policy and customer data to a third-party cloud provider rather than to another mortgage lender 220. Additionally, using cloud-based technologies, the size of the mortgage loan database 215 may be easily increased or decreased by allocating or deallocating cloud storage resources, without the need to purchase and install additional hardware into a datacenter.

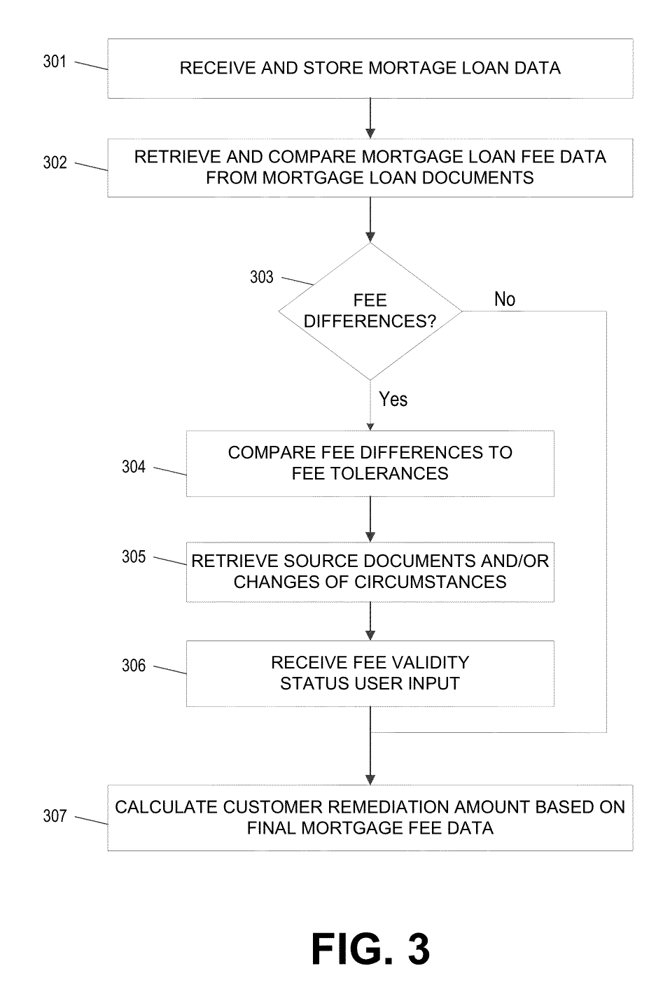

Referring now to FIG. 3, a flow diagram is shown illustrating a process of receiving and analyzing mortgage loan data to determine fee validity and calculate a customer remediation amount. Various embodiments and examples described below in connection with FIG. 3 may be performed by a compliance review computing device, such as a compliance review server 210, a mortgage lender computing device 220, a customer terminal 230, or by a combination of these devices or other devices in a compliance review system 200.

In step 301, data corresponding to one or more mortgage loans is received and stored by a compliance review computing device, such as compliance review server 210 or a mortgage lender server 220. The mortgage loan data received in step 301 may represent, for example, consumer home loans between a mortgage lender and a mortgage customer. In other examples, the mortgage loan data received and analyzed in the embodiments described herein may correspond to other loan types, such as home improvement loans, commercial loans, or automobile loans.

The mortgage loan data received in step 301 may include data regarding any mortgage loan fees charged to and/or paid by the customer during the mortgage loan process. As discussed below in more detail, consumer home loans (and other loan types) may include various customer fees charged by the mortgage lender and/or other parties to the loan process. A mortgage loan (e.g., a consumer home loan) may involve dozens or even hundreds of customer fees, each of which may have a separate set of mortgage fee rules and regulations with which mortgage lenders and other parties must comply.

In order to convey the customer fee data and other relevant loan data in step 301, one or more electronic loan documents may be transmitted to the compliance review server 210 in step 301. In some examples, one or more electronic loan files (e.g., Adobe Portable Document Format (PDF) scans of physical loan files, or various other electronic loan file formats) may be transmitted in step 301. In other examples, individual loan documents may be transmitted rather than entire loan files. For a consumer home loan, electronic copies of the HUD-1 Settlement Statement, one or more Good Faith Estimate (GFE) documents, a Settlement Servicers Provider List (SSPL), a Loan Pricing Agreement (LPA), and/or one or more Change of Circumstances (CoC) forms, among other various documents, may be included in the data transmitted in step 301. When transmitting electronic mortgage loan files in step 301, specialized hardware and/or software in the compliance review server 210, or in a separate security and integration layer 106, may be used to manage secure communications between the compliance review server 210 and the external devices or systems providing the data (e.g., mortgage lender devices 220, customer terminals 230). In such cases, the mortgage data files (e.g., loan files, HUD-1 and GFE documents, etc.) may be transmitted using secure protocols and/or encryption, such as SFTP or FTP with PGP encryption. The mortgage loan data received in step 301 also may be received via a web service developed in accordance with a service-based integration scheme provided by a compliance review server 210 and/or a security and integration layer 106. As discussed above, a secure web-service may use protocols and standards such as SSL or TLS, HTTP or HTTPS, SOAP with XML encryption, to allow for the secure transfer of mortgage loan data and/or customer financial data in step 301.

In other examples, rather than transmitting electronic copies of loan files or individual loan documents, the compliance review computing device (e.g., a compliance review server 210 or mortgage lender server 220) may be configured to provide a user interface to allow various users (e.g., customers, mortgage lender personnel, etc.) to input the relevant mortgage loan data and customer fee data. In some cases, the mortgage loan data received in step 301 may be received over a computer network from a customer terminal 230 or mortgage lender terminal 220, for example, via web-browser based forms, a mobile or non-mobile client compliance review software application, or the like. In other examples, the mortgage loan data may be received over other media and using other techniques, such as by email, an automatic voice response unit (VRU) during a telephone interaction, or by client-side or server-side scanning and parsing of hard copies of mortgage data forms (e.g., HUD-1 and GFE documents).

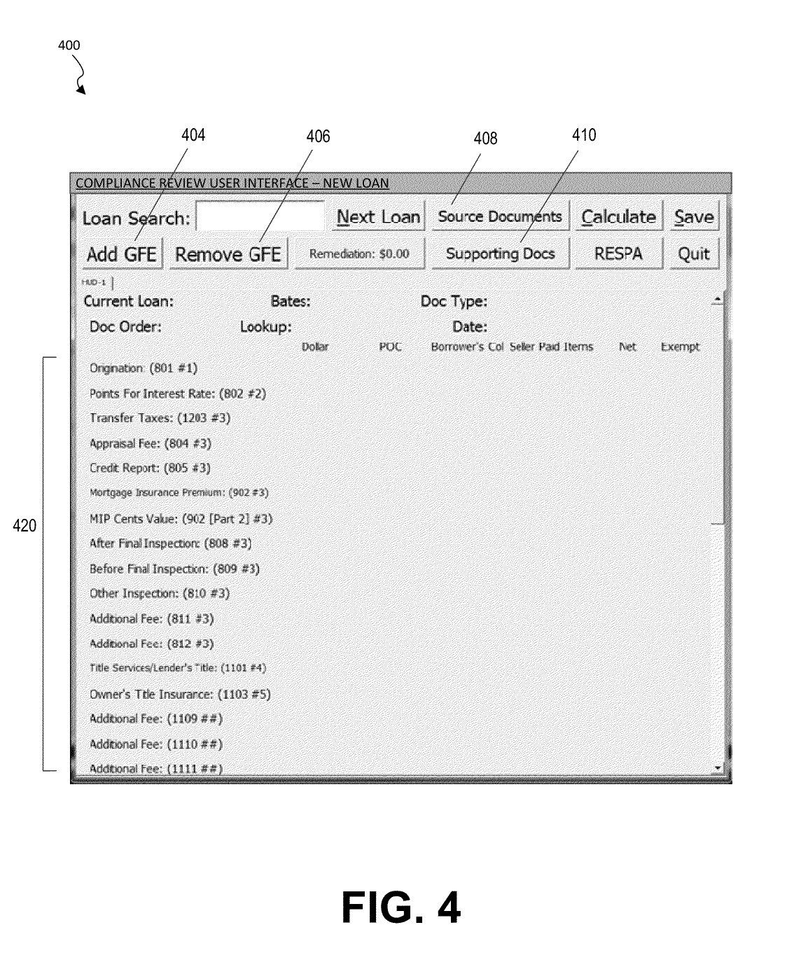

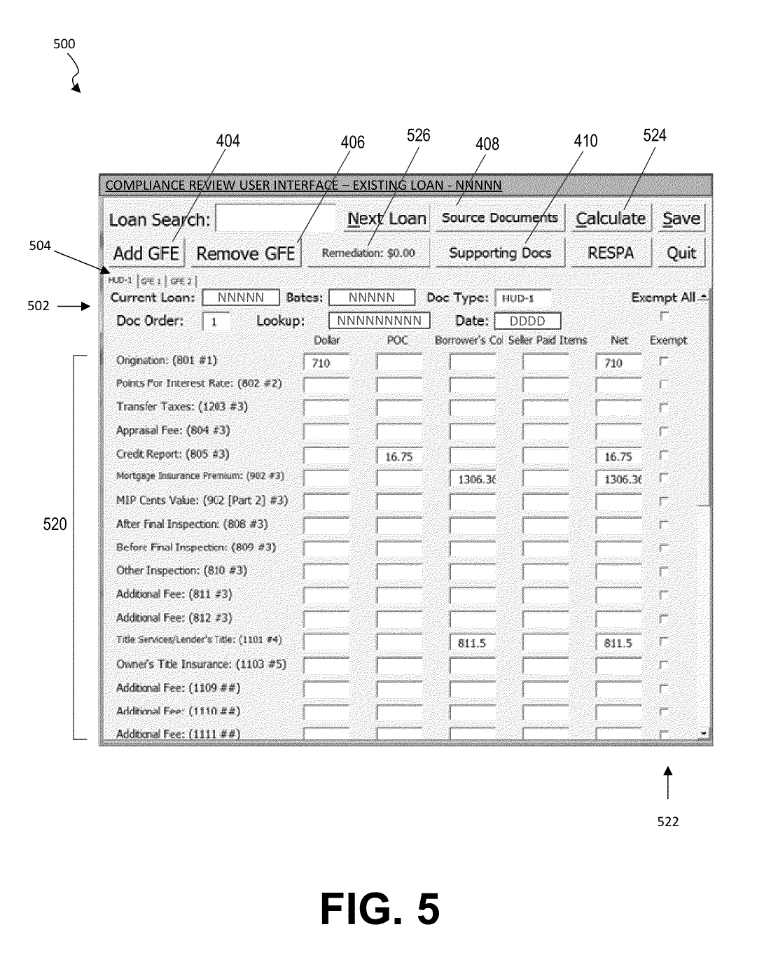

Referring to FIGS. 4 and 5, two example user interface screens are shown from a compliance review client software application configured to receive mortgage loan user input. FIG. 4 shows an example user interface screen 400 allowing a user (e.g., mortgage lender personnel or a mortgage customer) to input data corresponding to a new mortgage loan. FIG. 5 shows another example user interface screen 500 allowing a user to input mortgage data for an existing loan. In combination, these user interface screens allow a user, such as loan officer, loan processor, loan underwriter, or loan customer, to input the relevant loan data and customer fee data, in order to perform a compliance review for a mortgage loan. In these examples, users may input loan data (502), input data from HUD-1 settlement statements (402, 420), add or remove good faith estimates (GFE) documents associated with the mortgage loan (404, 406), and upload source documents and other relevant documents from the loan file (408, 410). Both user interface screens include a listing of customer fees (420, 520), into which the user may input the various customer fees reflected in the HUD-1 and the GFEs (if any) associated with the mortgage loan (504 and 520).

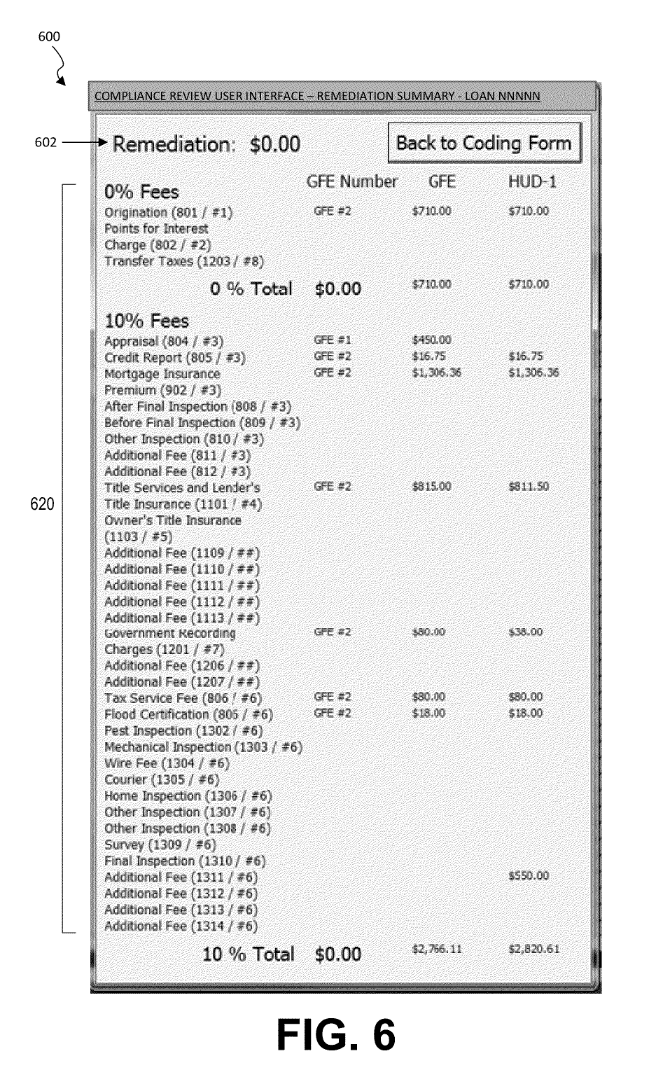

After inputting the customer fee data from the HUD-1 and/or GFEs for a loan in user interface screen 500, the user may exempt the customer from one or more fees using column 522, may calculate or update a customer remediation amount 524, and may view the current customer remediation amount 526. Referring briefly to FIG. 6, a related user interface screen 600 is shown corresponding to a remediation summary report. In this example, the total remediation amount 602 due to the customer is $0.00. The example remediation summary report 600 also includes a listing 620 of the customer fees from the relevant mortgage loan documents, grouped by fee change tolerances (e.g., 0% Fees and 10% Fees) and listing each customer fee from the HUD-1, the corresponding GFE and GFE fee. The fee change tolerances, fee exemptions, and calculations of customer remediation amounts are described in more detail below.

In step 302, multiple sets of the mortgage loan customer fee data received in step 301 are retrieved and compared by the compliance review computing device (e.g., a compliance review server 210 or mortgage lender server 220). A single mortgage loan may have multiple different sets of customer fee data, for example, one or more initial sets of customer fee data from one or more Good Faith Estimates (GFEs), and a final set of customer fee data from a HUD-1 document. There is no limit to the number of GFEs that may be associated with a mortgage loan, and thus no limit to the number of different sets of mortgage loan customer fee data that may be retrieved in step 302. Additionally, customer fee data may be retrieved from loan documents other than GFEs and HUD-1s, and other types of mortgage loan data received in step 301.

In certain embodiments, each individual fee from a set of mortgage loan customer fee data may be compared to a corresponding individual fee from another set of mortgage loan customer fee data. For example, referring again to FIGS. 4 and 5, the amount of each individual fee in the listing of customer fees (420, 520) in one fee set (e.g., a HUD-1 or GFE) may be compared against the same fee in a different fee set (e.g., HUD-1 versus a GFE, or one GFE versus another GFE). To illustrate, a single consumer home mortgage loan may have one or more associated GFEs, a HUD-1 document, and additional documents listing customer fee amounts for each of the fees below in Table 1, among others.

TABLE 1
Example List of Consumer Home Mortgage Loan Fees

Origination Charge
Points for Interest Rate
Transfer Taxes
Appraisal Fee
Credit Report Fee
Mortgage Insurance Premium
After Final Inspection
Before Final Inspection
Other Inspection
Title Services
Lender's Title Insurance
Owner's Title Insurance
Government Recording Charge
Tax Service Fee
Flood Certification
Pest Inspection
Mechanical Inspection
Wire Fee
Courier Fee
Home Inspection
Other Inspection
Survey
Final Inspection
Additional Fee(s)

In some examples, the compliance review computing device may retrieve and compare customer fee data from chronologically consecutive sets of mortgage loan customer fee data in step 302. For example, a mortgage loan may have three Good Faith Estimates documents containing customer fee estimations (GFE1 dated Apr. 1, 2013, GFE2 dated May 10, 2013, and GFE3 dated Jun. 20, 2013) and a settlement statement document containing the final customer fees (HUD-1 dated Jul. 25, 2013). In this example, the compliance review computing device may be configured to retrieve and compare each customer fee from each set of two consecutive documents (e.g., GFE1 versus GFE2, GFE2 versus GFE3, and/or GFE3 versus HUD-1), to identify any differences in the fee amounts or other fee discrepancies between consecutive sets of mortgage data.

In step 303, for each of the individual customer fees retrieved in step 302, the compliance review computing device 210 may identify any fee differences between the multiple sets of mortgage data. For example, if a first GFE lists an Appraisal Fee of $500, and a second GFE for the same loan lists the Appraisal Fee amount as $550, the compliance review computing device 210 would identify this as a fee difference (303:Yes) for the Appraisal Fee. As discussed above, the analysis in steps 302-303 may be performed on a fee-by-fee basis, so that certain fees may be identified as having fee differences (303:Yes) while other fees are consistent between the mortgage data sets (303:No). Thus, in step 303, the compliance review computing device 210 may be configured to perform an iterative comparison over a predetermined set of known customer fees (e.g., each fee in Table 1) or over each of the fees retrieved for one (or multiple) sets of mortgage data (e.g., each fee in one or more GFEs and/or the HUD-1).

When determining that no fees have changed between two different mortgage data sets, such as consecutive GFEs, or a final GFE and a HUD-1, etc. (303:No), then the example process of FIG. 3 proceeds to step 307, discussed below. However, for any customer fees having a fee difference between different GFEs, a GFE and the HUD-1, and/or other mortgage data fee differences (303:Yes), the compliance review computing device may be configured to perform a one or more tasks in steps 304-306 for each identified fee difference.

In step 304, after identifying a fee difference in step 303, the compliance review computing device may retrieve a predefined fee tolerance value and compare the fee difference to the fee tolerance for the identified fee. For instance, if an “Origination Charge” fee changed between subsequent GFEs, or between a final GFE and the HUD-1, the compliance review computing device may retrieve a fee tolerance for the Origination Charge fee, and compare the amount of the fee change to the Origination Charge fee tolerance. In some cases, fee tolerances may be determined by governmental regulations (e.g., RESPA and/or Reg. X), in order to assure consumers that a particular fee may not be altered by more than a specified amount from what was quoted to the customer in a GFE or other mortgage loan document. Fee tolerances may be expressed as dollar amounts, or as percentages (0%, 2%, 10%, 25%, 100%, etc.). In some cases, fee tolerances may be based on changes between consecutive mortgage loan documents, for example, a maximum dollar or percentage change for a fee between a first GFE and a second GFE, or between a final GFE and a HUD-1, etc. In other cases, fee tolerances may be based on a total fee change amount since an initial fee amount (e.g., a first fee, lowest fee, etc.), and thus may correspond to a maximum allowable dollar or percentage fee change throughout a mortgage loan process (e.g., from a first GFE or lowest fee GFE to the final HUD-1, etc.). In some embodiments, the predetermined fee tolerances may be stored on the compliance review computing device 210, for example, within a fee tolerance table/database, or hardcoded into the compliance review software code. In other examples, the compliance review computing device 210 may be configured to retrieve updated fee tolerance values from one or more external data sources, such as compliance regulation servers 240.

As discussed below, in some embodiments, a compliance review server 210 may be configured to automatically determine the validity statuses of customer fees (e.g., whether the fee is valid and should have been paid by the customer, or whether the fee is invalid and the customer should have been exempted from paying) based on the identification of fee differences in step 303, the comparison of fee differences to tolerances in step 304, and/or other various factors. Additionally, after automatically determining the validity status of various customer fees, the compliance review server 210 then may calculate a customer remediation amount, for example, by summing the differences (or variances) between any invalid fees previously paid by the customer during the mortgage loan process (e.g., exempt HUD-1 fees) and the corresponding valid fees from previous loan documents (e.g., valid fees from a most recent GFE).

However, in other embodiments, such as the example process illustrated in FIG. 3, a compliance review server 210 might not automatically determine the validity status of customer fees based on the fee differences identified in step 303 and the comparisons of fee differences to tolerances in step 304. Instead, the compliance review server 210 may be configured to highlight or tag certain customer fees as potentially invalid in a user interface. In such cases, the compliance review server 210 may then retrieve additional information or documents regarding the fee changes, present the additional information or documents to a user via a compliance review user interface, and receive input from users designating (i.e., tagging) the fees as valid or invalid.

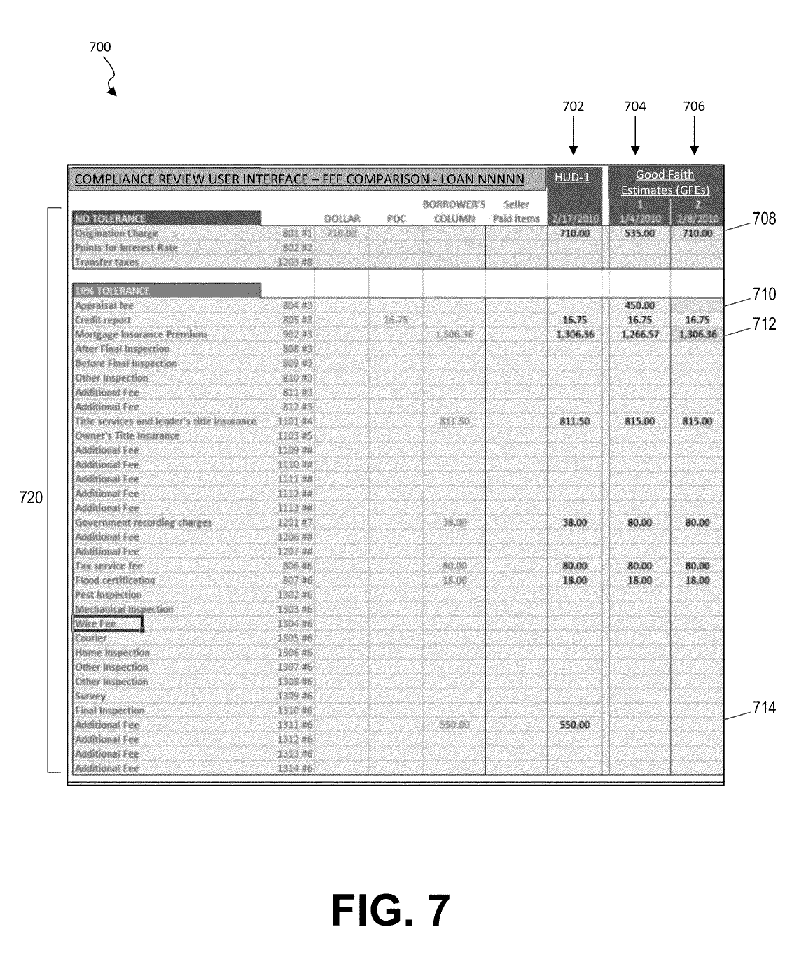

Referring now to FIG. 7, an example is shown of a fee comparison user interface screen 700, which may be provided by a compliance review web-page or client application from a compliance review computing device. The user interface screen 700 in this example includes a comparison of a set of customer fees 720 in a single mortgage loan, between a HUD-1 (customer fees in column 702), a first GFE (customer fees in column 704), and a second GFE 706 (customer fees in column 706). In this example, the compliance review server 210 has automatically highlighted three customer fees (708, 710, and 712) based on an identified fee difference between the first and second GFEs. The Origination Charge 708 (which has a zero fee change tolerance in this example) increased from $535 in the first GFE to $710 in the second GFE, the Appraisal Fee 710 (which has a ten percent fee change tolerance in this example) decreased from $450 in the first GFE to $0 in the second GFE, and the Mortgage Insurance Premium 712 (which also has a ten percent fee change tolerance in this example) increased from $1,266.57 in the first GFE to $1,306.36 in the second GFE. Thus, all three customer fees 708, 710, and 712 have been highlighted in the user interface 700, to alert the user that these fees are potentially invalid.

In the example shown in FIG. 7, only the fee differences between the first and second GFEs are highlighted. However, in other examples, the compliance review server 210 may highlight (or otherwise flag or indicate in the user interface) fee differences between the HUD-1 702 and either GFE 704-706. Thus, the Additional Fee 714 of $550 in the HUD-1, which was not present in either the first or second GFE, may be highlighted or tagged as potentially invalid in certain embodiments. Additionally, the user interface 700 in FIG. 7 is configured to highlight fee changes regardless of the change amount, and regardless of whether the fee increased or decreased for the customer. However, in other examples, the compliance review computing device might only highlight fee changes which exceed the tolerance for that particular fee. Fee 712, which was increased by less than the 10% tolerance, would not be highlighted or tagged in such cases. Additionally, in some examples, the compliance review computing device may be configured to highlight only customer fee increases, and not fee decreases. Fee 710, which decreased between the first GFE and the second GFE, would not be highlighted or tagged in such cases.

In step 305, the compliance review server 210 may be configured to retrieve source documents and/or change of circumstances documents corresponding to any customer fees for which fee differences were identified in step 303. Source documents may include the mortgage loan documents listing the relevant fees, such as HUD-1s, GFEs, and the like, from mortgage loan files. For example, if a particular customer fee (e.g., a Title Service Fee) changed between GFE1 and GFE2, the source documents retrieved in step 305 may include scanned copies of both GFE1 and GFE2 so that these documents can be reviewed by the user (e.g., a mortgage customer or mortgage lender personnel).

Additionally, one or more change of circumstances documents may be retrieved in step 305. A change of circumstances document may correspond to a REPSA Changed Circumstances Detail Form found in a mortgage loan file, or other similar document, and may describe a relevant change in the loan terms or underlying loan conditions. For example, change of circumstances documents may indicate changes in the requested loan amount, a change in the property value of the home being purchased, or a change in a customer's employment status, income, or credit score, or the like. Additional change of circumstances documents may correct a legal address error in a previous loan document, or may indicate a property type change, occupancy change, or property characteristic change in the property being purchased.

Changes in circumstances documents may be used to determine whether a customer fee change is valid or invalid, for example, when the original circumstances were used to determine the initial set of customer fees. For instance, a mortgage lender may provide a customer with a first GFE, including an initial set of estimated customer fees, based on incomplete information and/or the customer's representations about the property being purchased, the customer's financial situation, and other factors. If the mortgage lender receives updated information regarding the property, the customer's financial situation, or other relevant data, then the mortgage lender may provide a second GFE including a changed set of estimated customer fees. In this example, an increase in a particular customer fee between the first and second GFE may be valid based on the change in circumstances. However, changes of circumstances do not give mortgage lenders complete freedom to change any and all customer fees from previous mortgage fee estimates, such as previous GFEs. Governmental regulations may define the types of changes in circumstances, and amounts of the changes, that will justify corresponding changes in customer fees from one GFE to another, or from a final GFE to a HUD-1. Additionally, the amount of time between a change of circumstances and a subsequent customer fee change (e.g., an updated GFE provided by the mortgage lender after the change of circumstances) may be relevant in determining whether or not the customer fee change is valid. According to certain governmental regulations, a mortgage lender must provide a subsequent GFE including any customer fee increases within a predefined amount of time (e.g., 3 days) following a change in circumstances.

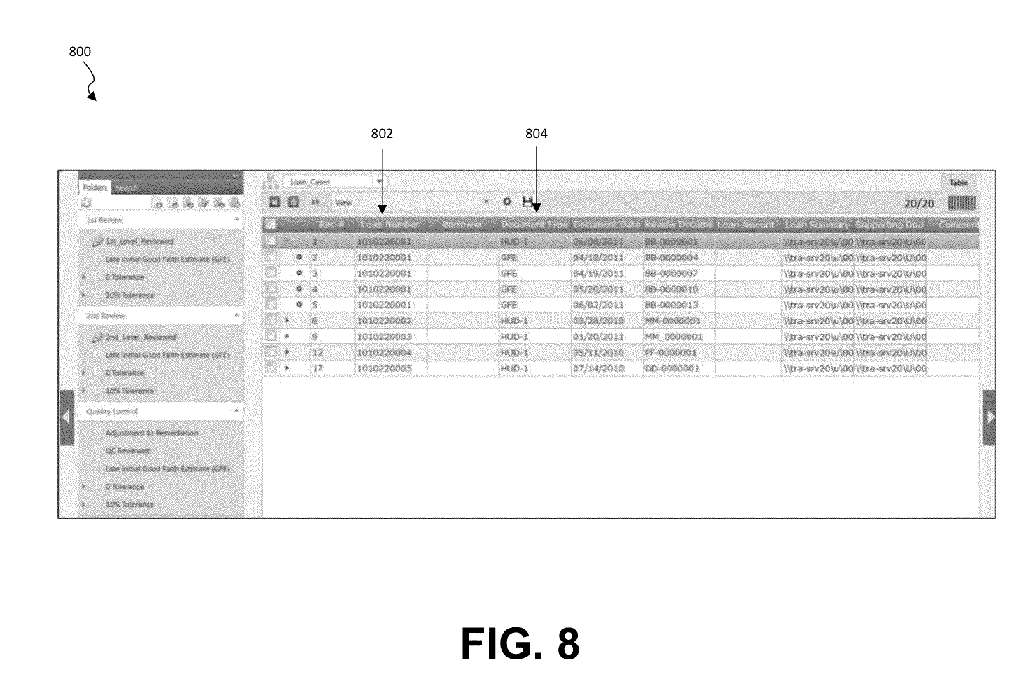

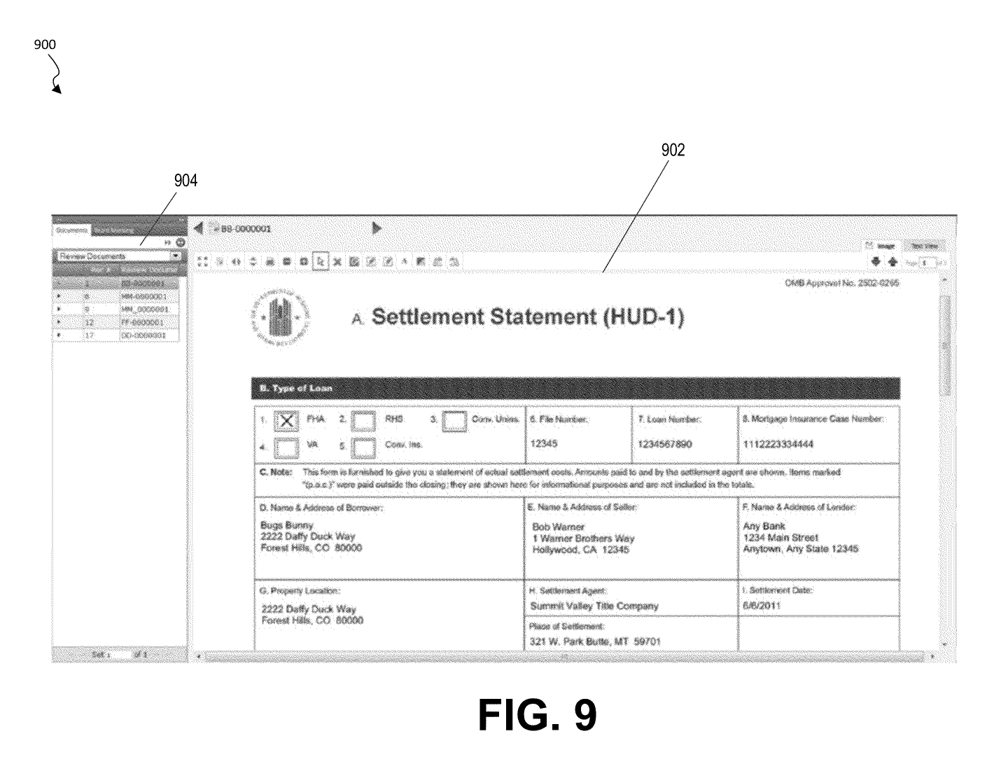

In step 305, the source documents and/or changes of circumstances documents retrieved by the compliance review computing device may be displayed via one or more user interface screens. As discussed below, by retrieving source documents (e.g., GFEs, HUD-1s, etc.) and change of circumstances documents, and making these documents available to users in a user interface, the compliance review computing device may allow users to more quickly review and determine validity statuses for customer fee changes. Referring to FIG. 8, a loan family user interface screen 800 is shown from which users may select loans and loan source documents for viewing. In this example, user interface screen 800 includes a collapsible loan document table, including a loan number, document type, and document date, among other fields, for each source document. As indicated by the loan number column 802 and document type column 804, the first loan listed in the table (loan #1010220001) includes a HUD-1 and four GFE documents. Referring to FIG. 9, a source document viewer user interface 900 is shown, in which a HUD-1 from an example loan is displayed in the primary viewing window. User interface 900 also includes a document selection pane 904 to allow the user to quickly select and view different source documents, change of circumstances documents, and other documents associated with the same mortgage loan.

In step 306, a compliance review computing device (e.g., a compliance review server 210, a mortgage lender server 220, and/or a customer terminal 230 executing compliance review software, etc.) may provide a user interface displaying the customer fees from one or more mortgage loans, and allowing users (e.g., mortgage customers, mortgage lender personnel, etc.) to designate validity statuses for the individual fees. In some embodiments, a compliance review computing device may receive user input via the user interface designating (or tagging) specific customer fees from a final set of mortgage data as valid or invalid.

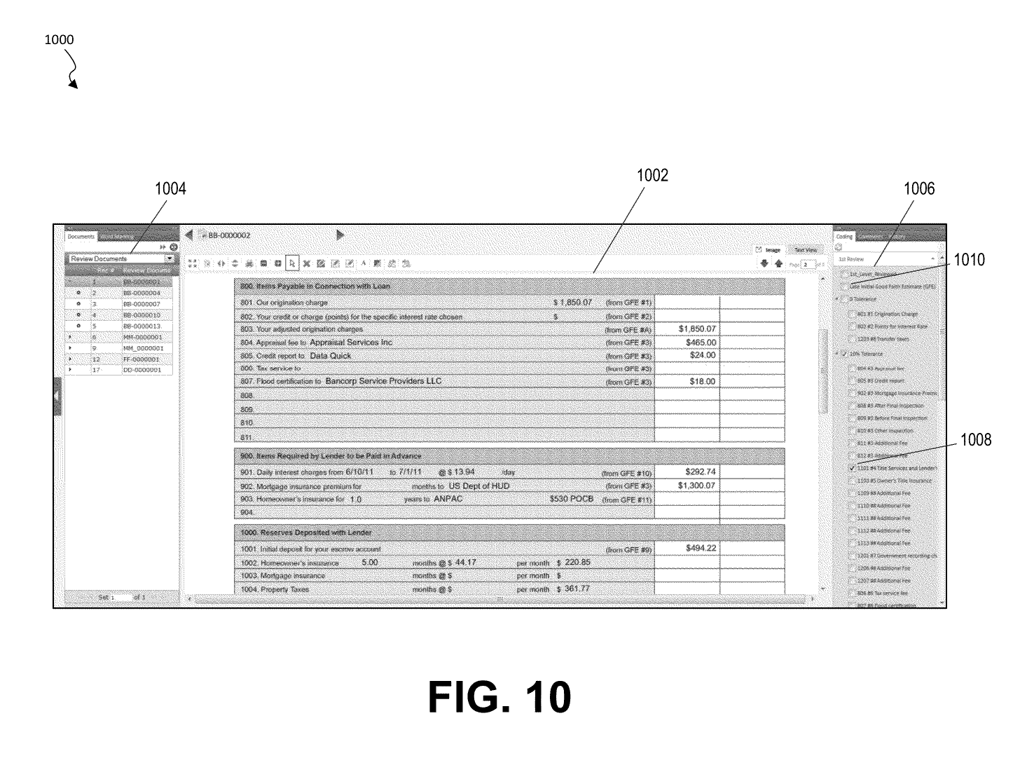

For example, referring to FIG. 10, a user interface 1000 is provided including a source document viewer window 1002, and a document selection pane 1004, display similar components to those shown in FIG. 9. Additionally, interface 1000 includes a fee tagging window 1006, which includes a selectable list of all customer fees associated with the selected mortgage loan. In this example, the customer fees listed in the fee tagging window 1006 are sorted by fee tolerances (e.g., 0 Tolerance Fees, 10% Tolerance Fees), and a selectable check box is provided for each fee to allow the user to tag that fee as invalid. In this case, based on the user's review of the HUD-1 shown in the source document viewer 1002, and the other loan documents available via the document selection pane 1004, the user has tagged a “Title Services and Lender's Title Insurance” fee 1008 from the HUD-1 as an invalid customer fee. In this example, the user also has the option 1010 of tagging an entire GFE as being late. As discussed above, in some cases, mortgage lenders may be required to provide updated GFEs within a predetermined time window (e.g., 3 days) after being notified of a change of circumstances relating to a loan. In this example, if a user tags the GFE as being late (by checking box 1010) after reviewing relevant source documents and change of circumstances documents in the document viewer window 1002, then the compliance review server 210 may automatically tag every fee from the late GFE within the fee tagging window 1006. In this case, the customer fees for the mortgage loan would revert back to the fees from the previous GFE, and any customer fees changed in the late GFE may be invalid.

In step 307, the compliance review computing device may calculate a customer remediation amount based on a final set of mortgage data, such as a HUD-1 or other loan documents. In examples when a compliance review process occurs following the final settlement of a mortgage loan, the customer remediation amount may be based on the invalid fees that were charged to and paid by the customer during the mortgage loan process. After determining that one or more of the customer fees is invalid, the compliance review computing device may determine that the customer is entitled to remediation based on the amount of the invalid fees paid, and the amounts of any corresponding valid fees from previous mortgage loan documents.

In some embodiments, the amount of customer remediation in step 307 may be calculated as the sum of differences between the tagged (i.e., invalid or exempt) fees from a final mortgage document (e.g., a HUD-1) and the corresponding valid (i.e., non-exempt) fees from a previous mortgage fee document (e.g., a most recent valid fee from a GFE). As discussed above (see FIGS. 6, 7, and 10, etc.), fees may be grouped based on different fee tolerances, such as 0% fees, 10% fees, etc. In certain examples, in order to calculate a customer remediation amount in step 307, separate remediation amounts may be calculated for each different fee tolerance group, and then summed. For instance, for each 0% fee, the final customer fee line item (e.g., from a HUD-1 mortgage document) may be compared to a corresponding valid fee from a previous mortgage document (e.g., a recent GFE). If the final fee is tagged, and thus is exempt/invalid, then the difference between the final fee amount and the corresponding previous valid fee will be calculated. For instance, if a tagged/exempt Flood Certification Fee on a final HUD-1 was $50, and the most recent valid Flood Certification Fee from a GFE was $30, then the fee difference of $20 would be calculated for the Flood Certification Fee. This process may be repeated for every final fee line item, for each 0% tolerance fee, and each of these fee differences may be summed to reach a total customer remediation amount for the 0% tolerance fee group. To illustrate, Table 2 shows an example of a customer remediation calculation for four tagged/exempt 0% tolerance fees from a HUD-1, by comparing the sum of the fees to their previous valid GFE fees.

TABLE 2
Example Customer Remediation Calculation
for 0% Tolerance Fees

| 0% Fee | Hud-1 Fee | Corresponding GFE Fee | Variance |
|---|---|---|---|
| Transfer Taxes | $285 | $240 (from GFE 2) | $45 |
| Appraisal Fee | $170 | $110 (from GFE 3) | $60 |
| Flood Cert. | $10 | 40 (from GFE 3) | −$30 |
| Survey | $350 | $250 (from GFE 1) | $100 |
| Total | $815 | $640 | $175 |

| | |
|---|---|
| 0% Fee Customer | Customer Remediation Amt. = Sum of Positive |
| Remediation | Variances = $175 |
| Amount | |

In some cases, a different procedure may be used for calculating a total customer remediation amount for different tolerance fee groups (e.g., 5% tolerance, 10% tolerance, . . . , % 100 tolerance, etc.). For example, in a 10% tolerance fee group (see FIGS. 6, 7, and 10, etc.), all final tagged/exempt fees from the fee group may be initially summed, and then compared to the sum of all of the previous corresponding valid fees, times 1.1, to determine the total customer remediation amount for the 10% tolerance fee group. To illustrate, Table 3 shows an example of a customer remediation calculation for four tagged/exempt 10% tolerance fees from a HUD-1, by comparing the sum of the fees to their previous valid GFE fees:

TABLE 3
Example Customer Remediation Calculation
for 10% Tolerance Fees

| 10% Fee | Hud-1 Fee | Corresponding GFE Fee | Variance |
|---|---|---|---|
| Origination Fee | $450 | $250 (from GFE 3) | $200 |
| Title Services | $50 | $75 (from GFE 2) | −$25 |
| Pest Inspection | $120 | $50 (from GFE 1) | $70 |
| Final Inspection | $310 | $300 (from GFE 3) | $10 |
| Total | $930 | $675 | $255 |

| | |
|---|---|
| 10% Fee Customer | $930 − $675 * 1.1 (for 10% tolerance) = $187.50 |
| Remediation | |
| Amount | |

As illustrated in Table 3 above, by initially summing the four exempt HUD-1 fees, and then comparing that value to the sum of the corresponding GFE fees (times 1.1 for the 10% tolerance), then customer remediation amount for the 10% tolerance fee group may be different than if the remediation amounts were separately calculated for fee line item and then summed.

In this example, the 0% Fee Customer Remediation Amount from Table 2 would be added to the 10% Fee Customer Remediation Amount from Table 3 (and any other remediation calculations from other fee tolerance groupings) to determine the total customer remediation amount. In still other examples, the calculation of the customer remediation amount in step 307 may take into account additional rules and regulations associated with customer remediation. For example, in some cases if a final fee on a HUD-1 is zero and/or if the fee is exempt, then the amounts of the HUD-1 fee and the corresponding GFE fee for that line item may be ignored for the customer remediation calculation.

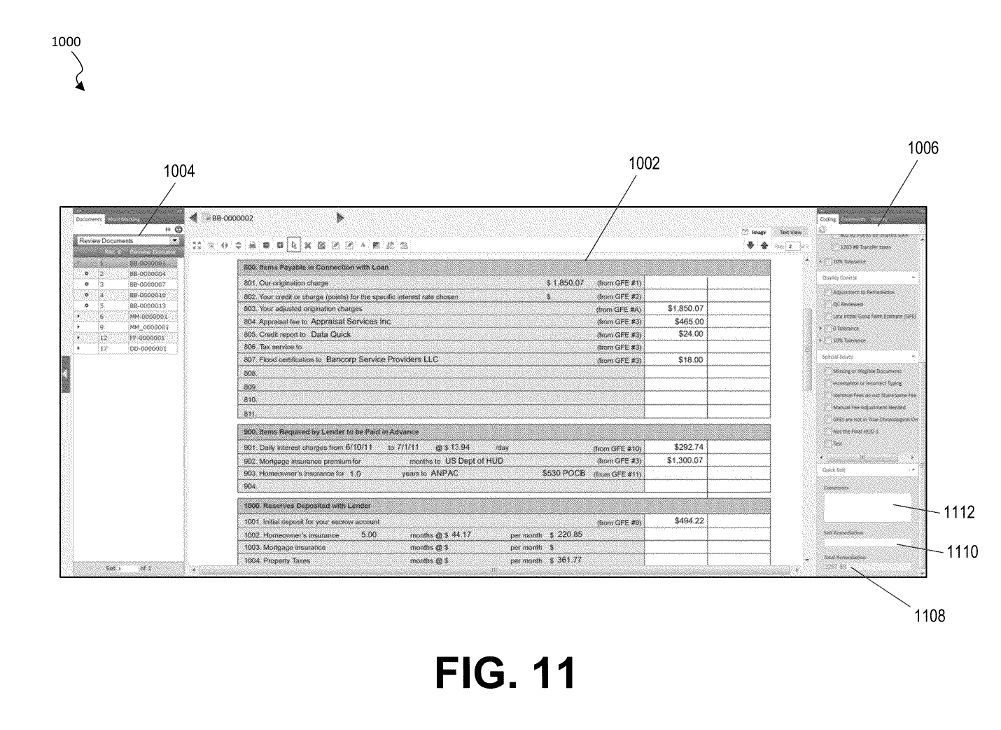

Referring to FIG. 11, a related view is shown of the same user interface 1000 from FIG. 10. In FIG. 11, the user has scrolled down the fee tagging window 1006, to reveal a total remediation field 1108, a self-remediation field 1110, and a comments field 1112. In this example, the total remediation field 1108 may be calculated automatically based on the customer fees tagged (i.e., designated as invalid) by the user in the fee tagging window 1006. That is, for any fees previously paid the customer during the mortgage loan process that are later tagged as invalid during the compliance review process, the customer may be entitled to receive remediation in the amount of the sum of the variances between the invalid fees paid and the corresponding valid fees from previous mortgage documents (e.g., a most recent GFE). In this example, the total remediation field may be dynamically updated by the compliance review server 210 in response to a user tagging (or un tagging) a fee, tagging (or untagging) an entire GFE as being late, or performing another action in the fee tagging window 1006 that affects customer remediation for the mortgage loan. In some cases, prior to the compliance review for a mortgage loan, a mortgage lender may have already identified and paid some amount of remediation to the customer. Customer remediation identified and paid by mortgage lenders before the compliance review is performed is indicated in the self-remediation field 1110. The compliance review server 210 may use the self-remediation field 1110 to calculate the total remediation field 1108. For example, if the compliance review server 210 calculates a customer remediation amount of $1,500 (e.g., based on the tagged/invalid fees in window 1006), but the mortgage lender has previously paid $500 in self-remediation to the customer (field 1110), then the compliance review server 210 may calculate the difference of $1,000 as the total remediation amount due to the customer (field 1108).

Thus, FIGS. 10 and 11 illustrate an example user interface 1000 that may be provided by a compliance review computing device, to display customer fees from a mortgage loan and allow users to designate validity statuses for the customer fees (step 306), and to calculate a customer remediation amount based on the received user input (step 307). Another example user interface that may be provided by a compliance review server 210 to provide similar functionality is shown in FIGS. 5 and 6. As discussed above, user interface 500 in FIG. 5 includes a listing of customer fees 520 for a selected mortgage loan, along with an exemption column 522 to allow users to tag specific fees as invalid (step 306). The user interface 500 also includes a dynamically updated customer remediation field 524 (step 307), and FIG. 6 shows a user interface 600 corresponding to a remediation summary report. The user interfaces in these examples, and various other examples, may be provided by a compliance review computing device (e.g., compliance review server 210, mortgage lender server 220, and/or customer terminal 230) via a web-browser based client-server application, a mobile software application, or other client application.

In the examples discussed above referring to FIG. 3, a compliance review computing device (e.g., compliance review server 210, mortgage lender server 220, and/or customer terminal 230) may be used to automatically identify customer fee differences between different sets of mortgage data, compare such differences to fee tolerances, and provide user interfaces to receive input from a user (e.g., a customer or mortgage lender personnel) regarding the validity of certain customer fees. However, in other examples, the compliance review computing device may be configured to automatically determine the validity statuses (e.g., valid or invalid) for specific customer fees, without receiving user input to determine the validity statuses. In such embodiments, a compliance review server 210 may be configured to automatically tag fees as invalid in response to one or more specific determinations, for instance, if a fee change is greater than a predefined fee change tolerance, if a fee change does not have an associated change of circumstances document, if a fee change document (e.g., a GFE) is submitted late with respect to an associated change of circumstances document, if a changed fee is not related to the change type in a change of circumstances document, and/or any combinations of these rules and other regulations for customer fee changes. Thus, in some cases, a compliance review computing device may be configured to automatically designate fee statuses as valid or invalid, and to calculate a customer remediation amount based on the fee statuses, without needing to provide any user interfaces to allow users to manually tag fees as valid or invalid.

In certain embodiments, one or more compliance review computing devices (e.g., compliance review server 210, mortgage lender server 220, and/or customer terminal 230) may be configured to provide multi-level user compliance reviews. In such embodiments, different levels of mortgage loan compliance review (e.g., a first review, a second review, . . . , a final review, a legal review, etc.) may be supported by the user interfaces of the compliance review system, and additional compliance review storage and logic may be implemented by the compliance review computing devices to provide a reviewing order and/or hierarchy of reviewers.

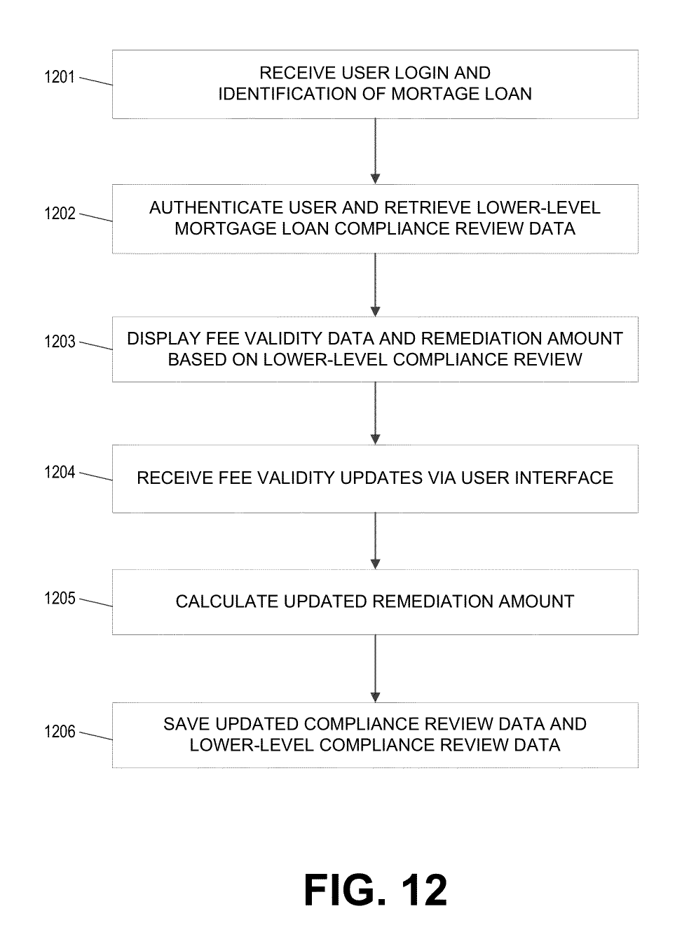

For example, referring to FIG. 12, a flow diagram is shown illustrating a process of calculating an updated remediation amount based on updated fee validity data in a multi-level compliance review. Various embodiments and examples described below in connection with FIG. 12 may be performed by a compliance review computing device (e.g., a compliance review server 210, a mortgage lender computing device 220, a customer terminal 230, or a combination of these devices or other devices in a compliance review system).

In step 1201, a user may login to a compliance review system, for example, a secure compliance review web-site, mobile application, or standalone client application, and may provide user credentials to a compliance review server 210 during the login process. In step 1202, the compliance review server 210 may authenticate the user and retrieve a corresponding set of mortgage loan compliance review data, based on the user's credentials. In some examples, different users may be authorized to input mortgage loan data (e.g., customer fee data) and to perform compliance reviews for different mortgage loans. For instance, a compliance review server 210 may be configured to enforce access permissions by which a customer may only access the compliance review user interface for the customer's mortgage loan; a loan officer may only access the compliance review user interface for the loan officer's mortgage loans, etc. Additionally, certain authenticated users (e.g., loan processors) may be designated as lower-level reviewers for specific loan cases, and may only have permissions to perform a first-level compliance review for a mortgage loan, while other users (e.g., loan auditors, managers, legal personnel, etc.) may be designated as higher-level reviewers and may have permissions to perform various different higher-level reviews, as discussed below. Thus, the mortgage loan data retrieved in step 1202, including the mortgage loan cases available for review, and the level of review permitted, may depend on the user's identity and credentials.

In step 1203, the compliance review computing device may provide a user interface to the authenticated user, allowing the user to perform a compliance review for one or more mortgage loans. The user interface provided in step 1203 may include some or all of the similar features as those in the user interfaces discussed above in reference to FIGS. 4-11. Additionally, in this example, the user authenticated in step 1202 may be a higher-level reviewer for a mortgage loan compliance review that has previously undergone one or more lower levels of compliance reviews. For instance, higher-level employee of a mortgage lender (e.g., a loan office or manager) may login to the compliance review user interface to review and modify a mortgage loan compliance review previously performed by a lower-level employee (e.g., a loan processor or data entry personnel). Accordingly, the user interface provided in step 1203 may be a higher-level reviewer interface, including the previously saved fee validity designations/status and customer remediation amount determined in the lower-level compliance reviews.

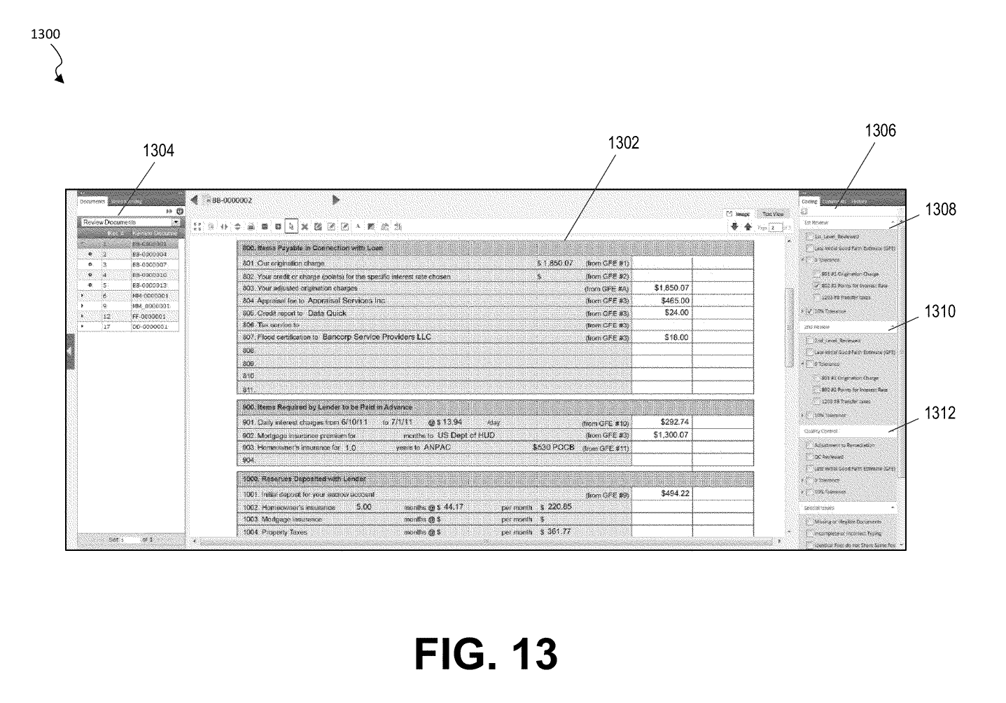

Referring now to FIG. 13, a compliance review user interface 1300 is shown, similar to the example user interfaces discussed above in FIGS. 9-11. In this example, after logging into the compliance review system in steps 1201-1202, a user may be provided a user interface screen 1300 (step 1203), including a document selection pane 1304 and a document source reviewer 1302 to allow the user to review mortgage loan documents (e.g., HUD-1s, GFEs, changes of circumstances forms, etc.) for any mortgage loan that the user is authorized to review. Additionally, user interface 1300 includes a fee tagging window 1306 configured to support a multiple levels of compliance reviews for the mortgage loan. In this example, the fee tagging window 1306 includes a first review section 1308, a second review section 1310, and a quality control review section 1312.

In some examples, when a user logs into the compliance review system and selects a mortgage loan to review, the previous compliance review may automatically retrieve and display any previous lower-level compliance reviews performed for the mortgage loan. For example, referring to FIG. 13, a user authorized as a first-level user may only see the first review section 1308, whereas a user authorized as a second-level user may see both the first review section 1308 (including the customer fees tagged by the previous reviewer), and the second review section 1308. A high-level quality control user in this example may see the first and second review sections 1308 and 1310 (including the customer fees tagged by the previous reviewers), and the quality control review section 1312, and so on. In certain embodiments, a compliance review computing device may require all lower-level compliance reviews to be performed and completed before allowing a user to perform a higher-level compliance review, thereby assuring that the multiple levels of compliance review are performed in a predefined order.

In step 1204, after presenting the higher-level user interface in step 1203, including the previous fee validity designations and the remediation amount from any lower-level reviews, the compliance review computing device may receive user input changing any of the previous lower-level fee designations (e.g., tagging or untagging a specific customer fee, tagging or untagging an entire GFE, or changing other customer fee data in the user interface. In step 1205, the compliance review computing device may dynamically update a customer remediation amount (e.g., the total remediation field 1108) based on the fee validity updates provided by the higher-level review in step 1204. For example, a first-level review designating three different customer fees as invalid may result in a first-level customer remediation amount equaling the sum of the differences of the three invalid fees minus the corresponding valid fees from a most recent previous document (e.g., a most recent GFE). If a higher-level (e.g., a second-level) reviewer updates one of the fee designations in step 1204 to indicate that the fee is valid, then the compliance review computing device may dynamically recalculate the customer remediation amount in step 1205 as the sum of the two remaining invalid fees.

In step 1206, after the completion of the higher-level compliance review, the compliance review computing device may save the lower-level compliance review data (e.g., the customer fee validity designations, remediation amounts, etc.) from one or more lower-level reviews, and may also save the updated higher-level compliance review data (e.g., the updated customer fee validity designations, remediation amounts, etc.). In some cases, the lower-level compliance review data may be preserved by the compliance review system, even though the highest-level review may dictate the customer remediation amount for a mortgage loan. In such examples, the lower-level compliance review data may be preserved to order to assist future higher-level reviewers, such as a third-level quality control reviewer, who may agree with the initial assessment of a first-level reviewer rather than a subsequent second-level reviewer. Additionally, the lower-level compliance review data may be preserved in order to generate compliance reports for various loan types and other loans having common characteristics, and to analyze the performance of various compliance review personnel (e.g., compliance report cards for various mortgage lender offices or personnel, etc.).

While the aspects described herein have been discussed with respect to specific examples including various modes of carrying out aspects of the disclosure, those skilled in the art will appreciate that there are numerous variations and permutations of the above described systems and techniques that fall within the spirit and scope of the invention.

1. A compliance review computing device, comprising:
one or more hardware memory units configured to receive and store thereon mortgage loan data; and
one or more processors configured to analyze mortgage loan data;
wherein the compliance review computing device is configured to access and employ the memory units and processors to:
receive first mortgage loan data comprising a plurality of first estimated mortgage fees associated with a first mortgage loan between a lender and a customer;
receive second mortgage loan data comprising a plurality of final mortgage fees associated with the first mortgage loan;
for each of the plurality of final mortgage fees, compare an amount of the final mortgage fee to an amount of a corresponding estimated mortgage fee from the plurality of first estimated mortgage fees, and determine a validity status for the final mortgage fee based on the comparison; and
calculate a customer remediation amount for the first mortgage loan, based on the determined validity statuses and fee amounts for one or more of the plurality of final mortgage fees.

2. The compliance review computing device of claim 1, wherein determining the validity status for a first final mortgage fee comprises:
determining a fee difference between the amount of the first final mortgage fee and a corresponding estimated mortgage fee from the plurality of first estimated mortgage fees;
determining a fee tolerance associated with the first final mortgage fee; and
determining whether the fee difference is within the fee tolerance associated with the first final mortgage fee.

3. The compliance review computing device of claim 1, wherein determining the validity status for a first final mortgage fee comprises:
determining a fee difference between the amount of the first final mortgage fee and a corresponding estimated mortgage fee from the plurality of first estimated mortgage fees;
identifying a first electronic source document relating to a change of circumstances for the first mortgage loan between a first date associated with the first mortgage loan data and a second date associated with the second mortgage loan data; and
providing a user interface for analyzing first final mortgage fee, the user interface comprising an indication of the fee difference and a viewing window for the first electronic source document.

4. The compliance review computing device of claim 1, wherein the first mortgage loan data further comprises a plurality of second estimated mortgage fees associated with the first mortgage loan, wherein the plurality of first estimated mortgage fees corresponds to a first mortgage loan estimation document issued on a first date, and the plurality of second estimated mortgage fees corresponds to a second mortgage loan estimation document issued on a second date after the first date.

5. The compliance review computing device of claim 4, wherein the compliance review computing device is configured to access and employ the memory units and processors to:
for each of the plurality of second estimated mortgage fees, compare an amount of the second estimated mortgage fee to an amount of a corresponding first estimated mortgage fee, and determine a validity status for a corresponding final mortgage fee based on the comparison.

6. The compliance review computing device of claim 4, wherein determining the validity status for a first final mortgage fee comprises:
determining a fee difference between a second estimated mortgage fee and a first estimated mortgage fee corresponding to the first final mortgage fee;
determining a fee tolerance associated with the first final mortgage fee; and
determining whether the fee difference is within the fee tolerance associated with the first final mortgage fee.

7. The compliance review computing device of claim 4, wherein determining the validity status for a first final mortgage fee comprises:
determining a fee difference between a second estimated mortgage fee and a first estimated mortgage fee corresponding to the first final mortgage fee;
retrieving an electronic record corresponding to a change of circumstances for the first mortgage loan between the first date and the second date, and determining a third date associated with the change of circumstances; and
calculating a difference between the third date associated with the change of circumstances and the second date corresponding to the issuance of the second mortgage loan estimation document.

8. A method, comprising:
receiving, by a compliance review computing device, first mortgage loan data comprising a plurality of first estimated mortgage fees associated with a first mortgage loan between a lender and a customer;
receiving, by the compliance review computing device, second mortgage loan data comprising a plurality of final mortgage fees associated with the first mortgage loan;
comparing, by the compliance review computing device, an amount of the final mortgage fee to an amount of a corresponding estimated mortgage fee from the plurality of first estimated mortgage fees, for each of the plurality of final mortgage fees;
determining, for each of the plurality of final mortgage fees, a validity status for the final mortgage fee based on the comparison, by the compliance review computing device; and
calculating, by the compliance review computing device, a customer remediation amount for the first mortgage loan, based on the determined validity statuses and fee amounts for one or more of the plurality of final mortgage fees.

9. The method of claim 8, wherein determining the validity status for a first final mortgage fee comprises:
determining a fee difference between the amount of the first final mortgage fee and a corresponding estimated mortgage fee from the plurality of first estimated mortgage fees;
determining a fee tolerance associated with the first final mortgage fee; and
determining whether the fee difference is within the fee tolerance associated with the first final mortgage fee.

10. The method of claim 8, wherein determining the validity status for a first final mortgage fee comprises:
determining a fee difference between the amount of the first final mortgage fee and a corresponding estimated mortgage fee from the plurality of first estimated mortgage fees;
identifying a first electronic source document relating to a change of circumstances for the first mortgage loan between a first date associated with the first mortgage loan data and a second date associated with the second mortgage loan data; and
providing a user interface for analyzing first final mortgage fee, the user interface comprising an indication of the fee difference and a viewing window for the first electronic source document.

11. The method of claim 8, wherein the first mortgage loan data further comprises a plurality of second estimated mortgage fees associated with the first mortgage loan, wherein the plurality of first estimated mortgage fees corresponds to a first mortgage loan estimation document issued on a first date, and the plurality of second estimated mortgage fees corresponds to a second mortgage loan estimation document issued on a second date after the first date.

12. The method of claim 11, further comprising:
for each of the plurality of second estimated mortgage fees, comparing an amount of the second estimated mortgage fee to an amount of a corresponding first estimated mortgage fee, and determining a validity status for a corresponding final mortgage fee based on the comparison.

13. The method of claim 11, wherein determining the validity status for a first final mortgage fee comprises:
determining a fee difference between a second estimated mortgage fee and a first estimated mortgage fee corresponding to the first final mortgage fee;
determining a fee tolerance associated with the first final mortgage fee; and
determining whether the fee difference is within the fee tolerance associated with the first final mortgage fee.

14. The method of claim 11, wherein determining the validity status for a first final mortgage fee comprises:
determining a fee difference between a second estimated mortgage fee and a first estimated mortgage fee corresponding to the first final mortgage fee;
retrieving an electronic record corresponding to a change of circumstances for the first mortgage loan between the first date and the second date, and determining a third date associated with the change of circumstances; and
calculating a difference between the third date associated with the change of circumstances and the second date corresponding to the issuance of the second mortgage loan estimation document.

15. One or more non-transitory computer-readable media having instructions stored thereon that, when executed, cause a computing device to:
receive first mortgage loan data comprising a plurality of first estimated mortgage fees associated with a first mortgage loan between a lender and a customer;
receive second mortgage loan data comprising a plurality of final mortgage fees associated with the first mortgage loan;
for each of the plurality of final mortgage fees, compare an amount of the final mortgage fee to an amount of a corresponding estimated mortgage fee from the plurality of first estimated mortgage fees, and determine a validity status for the final mortgage fee based on the comparison; and
calculate a customer remediation amount for the first mortgage loan, based on the determined validity statuses and fee amounts for one or more of the plurality of final mortgage fees.

16. The one or more non-transitory computer-readable media of claim 15, wherein determining the validity status for a first final mortgage fee comprises:
determining a fee difference between the amount of the first final mortgage fee and a corresponding estimated mortgage fee from the plurality of first estimated mortgage fees;
determining a fee tolerance associated with the first final mortgage fee; and
determining whether the fee difference is within the fee tolerance associated with the first final mortgage fee.

17. The one or more non-transitory computer-readable media of claim 15, wherein determining the validity status for a first final mortgage fee comprises:
determining a fee difference between the amount of the first final mortgage fee and a corresponding estimated mortgage fee from the plurality of first estimated mortgage fees;
identifying a first electronic source document relating to a change of circumstances for the first mortgage loan between a first date associated with the first mortgage loan data and a second date associated with the second mortgage loan data; and
providing a user interface for analyzing first final mortgage fee, the user interface comprising an indication of the fee difference and a viewing window for the first electronic source document.

18. The one or more non-transitory computer-readable media of claim 15, wherein the first mortgage loan data further comprises a plurality of second estimated mortgage fees associated with the first mortgage loan, wherein the plurality of first estimated mortgage fees corresponds to a first mortgage loan estimation document issued on a first date, and the plurality of second estimated mortgage fees corresponds to a second mortgage loan estimation document issued on a second date after the first date.

19. The one or more non-transitory computer-readable media of claim 18, having further instructions stored thereon that, when executed, cause the computing device to:
for each of the plurality of second estimated mortgage fees, compare an amount of the second estimated mortgage fee to an amount of a corresponding first estimated mortgage fee, and determine a validity status for a corresponding final mortgage fee based on the comparison.

20. The one or more non-transitory computer-readable media of claim 18, wherein determining the validity status for a first final mortgage fee comprises:
determining a fee difference between a second estimated mortgage fee and a first estimated mortgage fee corresponding to the first final mortgage fee;
determining a fee tolerance associated with the first final mortgage fee; and
determining whether the fee difference is within the fee tolerance associated with the first final mortgage fee.
